(19) United States
(12) Patent Application Publication
(10) Pub. No.: US 2013/0252092 A1
(43) Pub. Date: Sep. 26, 2013

(54) Lithium Ion Battery

(71) Applicant: LONG POWER SYSTEMS (SUZHOU) CO., LTD., Suzhou (CN)

(72) Inventor: Biying Huang, Suzhou (CN)

(73) Assignee: Long Power Systems (Suzhou) Co., Ltd., Suzhou (CN)

(21) Appl. No.: 13/850,354

(22) Filed: Mar. 26, 2013

(30) Foreign Application Priority Data
Mar. 26, 2012 (CN) 201210081945.1

(51) Int. Cl. H01M 4/76

(52) U.S. Cl. CPC H01M 4/762
USPC 429/211

(57) ABSTRACT

The present invention is related with a novel fabrication technique for a lithium ion battery, consisting of a cathode layer and an anode layer. The cathode and the anode layer are configured through a separator in between. The cathode or the anode layer comprises: a current collector with porous three-dimensional network construction; an electrode active material, filled in the pores and onto the both sides of the abovementioned current collector; and a layer of porous ionic conductive polymer layer, coated on the abovementioned current collector holding the electrode material. In the abovementioned lithium ion battery, the cathode or the anode layer comprises both the current collector and the electrode material. The current collector connects with the electrode material through its porous three-dimensional network and thus improves the active material utilization, capacity and energy density of the lithium ion battery.

### TECHNICAL FIELD

The present invention relates to a lithium ion battery field. More particularly, it relates to a novel lithium ion battery technology.

### BACKGROUND OF THE INVENTION

The traditional lithium ion battery comprises at least one pair of cathode and anode layers. The cathode and the anode layer are configured through a separator in between. The fabrication process for the cathode and the anode is usually as follows: the electrode material is coated on the solid metal foil through a binder. There are several disadvantages for such a fabrication process: (1) less loading of the electrode active materials due to more binder used and more current collector volume occupied yields to a lower area density of electrode active materials; (2) relatively weak binding between the electrode materials and the smooth surface of the current collector causes poor mechanical properties and limited anti-deformation capability of the electrode materials during the fabrication process and furthermore the electrode materials are prone to lose from the current collector. Accordingly, the lithium ion batteries made by such a traditional process usually have less satisfactory electrochemical performances such as low capacity, high impedance, and short cycle life. Furthermore, it also delivers high production cost and low production yield.

Generally solid metal foils such as stainless steel, aluminum, copper are selected as the current collector materials for battery electrodes. During cycling, with the electrode active materials undergoing lithium ion intercalation and deintercalation, their volume experiences expansion and contraction, for example, SiO₂ has a volume change as high as 400% during cycling, and the mechanical stress generated due to the volume change accumulates with the prolonged cycling. Consequently, the accumulated stress could peel the electrode materials off from the current collector and the active materials lose close contact with each other and with the current collector. Accordingly, the cell impedance grows with the cycling and poor cycling performance is obtained. To avoid such a technical problem, the traditional electrode fabrication method allows relatively thin electrode and thus a low area density.

In the subsequent battery fabrication steps of the traditional method, in order to obtain the targeted capacity and energy density, thick coatings and a large amount of multilayer electrode stacks are demanded. However, thick coating brings to poor processability of the electrodes; multilayer stacks create high cell impedance and poor cycling performance. Furthermore, both of which lead to a high production cost. On the other hand, the traditional battery fabrication includes multiple steps which are correlated with each other and this yields to great difficulty for process and performance optimization such as cell impedance, cycle life, capacity and energy density and so on. Thick coating layers further bring to low mechanical properties of the electrode and the electrode materials are prone to peel off from the current collector or just crack. As a result, the electrode and the current collector are detached from each other or the electrode materials disconnect from each other themselves. Therefore the construction and shape of the battery products by such a traditional method are restricted, particularly for the wounded cells.

### SUMMARY OF THE INVENTION

Based on the current existing technical problems abovementioned in the traditional battery electrode fabrication method, it is necessary to develop an innovative fabrication technique to improve the electrode active material utilization and the electrode processability.

A lithium ion battery, consisting of:

at least one pair of cathode and anode layer, the cathode and the anode layer are configured through a separator in between, wherein the cathode or the anode layer comprises:

a current collector with porous three-dimensional network construction; the electrode active materials, filled in the pores of the above mentioned current collector;

a porous ionic conductive polymer binder, dip coated on the abovementioned current collector holding the electrode materials.

In a particular embodiment of the invention, the abovementioned current collector is porous metal foam with the porosity ranging from 20%˜95%.

In another embodiment of the invention, the abovementioned electrode active material is a lithium ion compound selected from at least one of the following: Li₃V₂(PO₄)₃, LiFeMPO₄, LiMnO₂ and LiFePO₄, wherein M represents Ni, Co, Mn, Mg, Ca, Cr, V, Sr in LiFeMPO₄.

In another embodiment of the invention, the abovementioned electrode active material is selected from at least one of the following: C, Si, SiO₂, N containing compound, SnO₂, Sb₂O₃ and Li₄Ti₅O₁₂.

In another embodiment of the invention, the abovementioned electrode material is coated with the carbonized substance through the calcination process.

In another embodiment of the invention, the abovementioned porous ionic conductive polymer binder is selected from at least one of the following: PVDF, PTFE, PEO, PMA, or acrylate based gel polymer.

In another embodiment of the invention, the viscosity of the abovementioned porous ionic conductive polymer binder ranges from 0.1 Pa.s to 10 Pa.s.

In another embodiment of the invention, the separator material is selected from at least one of the following: PE, PP, PE/PP, PP/PE/PP.

In another embodiment of the invention, the abovementioned cathode or the anode layer is in a plate-like form with a uniform thickness.

In another embodiment of the invention, the abovementioned cathode or the anode layer comprises the current collector, the electrode active material filled in the porous current collector and the porous ionic conductive polymer binder coated on the current collector such that after assembling the cathode, separator and anode layer together the whole cell is also covered with a layer of porous ionic conductive polymer binder.

In the abovementioned lithium ion battery, the cathode or the anode layer comprises the current collector and the electrode active material. The current collector connects with the electrode active material through its three-dimensional network such that active materials' utilization is improved and relatively a high area density and energy density of the electrode is obtained. In addition, the current collector containing the electrode material tis coated with a porous ionic conductive polymer binder such that closer stack with other electrodes and lower cell impedance is achieved; Furthermore, the porous ionic conductive polymer binder can prevent the electrode material peeling off from the current collector.

### DETAILED DESCRIPTION OF THE DRAWINGS

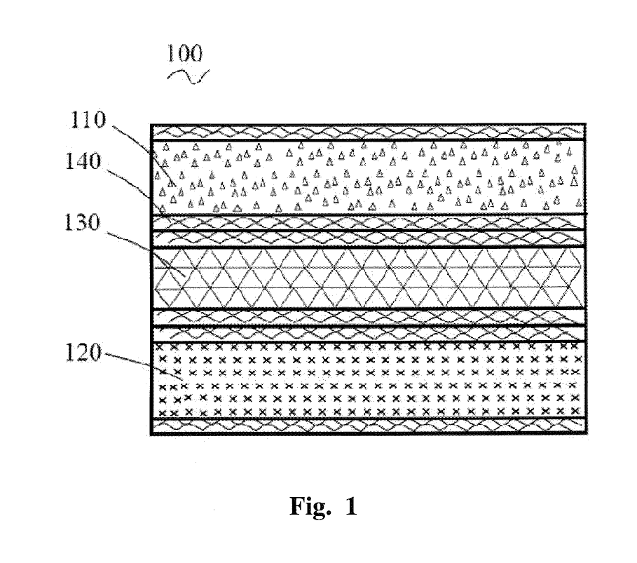

FIG. 1 is a diagrammatic view showing the structure of a unit cell of a battery according to one embodiment of the present invention.

### DETAILED DESCRIPTION OF THE PREFERRED EMBODIMENT(S)

Hereinbelow, the lithium ion battery 100 construction disclosed in the present invention will be described in detail with reference to FIG. 1, wherein the battery comprises at least one pair of cathode layer 110 and anode layer 120. The cathode layer 110 and the anode layer 120 are configured through a separator 130 in between.

The cathode layer 110 and the anode layer 120 of the battery cell 100 in the disclosed invention are both composite materials, comprising: the porous current collector with three-dimensional network structure; the electrode active material filled in the pores and on the both sides of the abovementioned current collector; and the porous ionic conductive polymer binder coated on the abovementioned current collector and the electrode material. In particular, the porous ionic conductive polymer binder layer coated on the current collector enables the cathode layer 110 and the anode layer 120 to have close contact with no free space and thus lowers the cell impedance; meanwhile the polymer binder can prevent the electrode materials loss from the current collector.

The current collector is generally porous metal foam with the porosity of 20%˜95%. The material for the current collector is selected from Al, Cu, Ni, Ag, Au or their alloy or stainless steel and so on. The electrode active material is filled in and onto the both sides of the current collector and they form continuous three-dimensional network structure. Furthermore, the carbonized substance is coated on the current collector and the electrode material through calcination and this enables more tight binding between the current collector and the electrode material.

Based on the abovementioned design concept, the electrode can be thus fabricated for the lithium ion battery cathode and anode. For the cathode, the electrode active material is a lithium ion compound, selected from at least one of the following: Li₃V₂(PO₄)₃, LiFeMPO₄, LiMnO₂ and LiFePO₄, wherein M represents Ni, Co, Mn, Mg, Ca, Cr, V, Sr in LiFeMPO₄. For the anode, the electrode active material is selected from at least one of the following: C, Si, SiO₂, N containing compound, SnO₂, Sb₂O₃ and Li₄Ti₅O₁₂. In particular, the C not only includes graphite (artificial or natural), but also includes graphitized carbon fiber, mesocarbon microbeads (MCMB), hard carbon and carbon nanotube.

In the embodiment of the invention, the complex electrode is generally processed to a plate-like form with a certain uniform thickness ranging from 100 μm to 100 cm for the convenience of the battery design and assembling. A layer of porous ionic conductive polymer binder solution 140 is dip coated on both the surface of the plate-like form of the electrode and the current collector after pressing the complex electrode. Such construction has the advantages of close pack of electrode with no free space, lower cell impedance and prevention of electrode material loss from the current collector.

The porous ionic conductive polymer binder is selected from at least one of the following: PVDF, PTFE, PEO, PMA, or acrylate based gel polymer. The viscosity of the polymer ranges from 0.1 Pa.s to 10 Pa.s. The thickness of the polymer binder dip coated on the current collector is ranging from 0.1 μm to 10 μm.

Referring to FIG. 1, as a further improvement, the both sides of the separator 130 are also attached with a binding layer 132, for which a porous ionic conductive polymer binder could also be used. Such a layout enables the separator 130 and its upper binding layer 132 together to form a composite separator material acting as a bridge between the cathode layer 110 and the anode layer 120. In addition, such a layout leads to more efficient binding and ionic conduction between the cathode layer 110 and the anode layer 120. The separator 130 is selected from at least one of the following: PE, PP, PE/PP, PP/PE/PP.

By applying a porous ionic conductive polymer binder on the both sides of the separator 130, the cathode layer 110 and the anode layer 120 are also surrounded with a layer of porous polymer binder such that all the components of the whole battery cell 100 closely contact with each other with no vacant space, leading to relatively low impedance of the cell. Furthermore, the porous ionic conductive polymer binder can prevent the electrode active material loss from the current collector.

The present invention is still disclosed a lithium ion battery fabrication technique, wherein the process consists of the following steps:

Step 1. The preparation method of a porous ionic conductive polymer binder 140 is as follows: dissolve the polymer binder in a correspondent solvent to form a glue-like solution with a certain viscosity;

Step 2. The composite cathode is fabricated as follows: mix the cathode active material and a conductive additive with the abovementioned ionic conductive polymer binder solution thoroughly to form electrode slurry. Use a doctor blade to coat the electrode slurry onto the both sides of the correspondent porous current collector foam. Dry the current collector holding the electrode material to remove the solvent. Then press the current collector plus the electrode material into a certain designed thickness. Under the inert atmosphere, calcine the composite electrode materials on the current collector to obtain the carbonized substance located in between the electrode active material and the current collector. Thereafter, the porous ionic conductive polymer binder 140 is dip coated on the current collector and the electrode. After removing the solvent in the binder solution by drying the whole piece of electrode in a vacuum oven, a composite cathode with the electrode active material, the carbonized substance, the current collector and the porous ionic conductive polymer binder 140 is obtained.

Step 3. The fabrication of a composite anode is as same as that of a composite cathode as described in Step 2.

Step 4. The composite separator is fabricated as follows: the porous ionic conductive polymer binder solution is dip coated on the both sides of the separator 130, the solvent is removed by drying the dip coated separator in a vacuum oven and finally the composite separator containing the porous ionic conductive polymer binder 140 is obtained.

Step 5. The fabrication method of a lithium ion battery is as follows: the abovementioned composite cathode, composite separator and the composite anode are stacked together following the order shown in FIG. 1. Under a certain temperature, a certain stress is applied onto the stack such that the electrode materials and the separator are packed more tightly to remove free air and minimize cell impedance.

In the abovementioned fabrication process, the drying temperature for the current collector holding the electrode slurry is 100° C.˜120° C. and the drying time is 1˜12 hrs. The organic binder is stable in the non-aqueous battery and it is selected from one of the following: polyethylene (PE), polypropylene (PP), polybutylene (PB), carboxymethylcellulose (CMC), PVDF, PTFE, PAN, EPDM rubber, styrene butadiene rubber (SBR) or polyurethane (PU). The electro-conductive additive in the electrode formulation is selected from carbon black, acetylene black, carbon nanotube, conductive carbon or vapor grown carbon fiber (VGCF). NMP is generally used as the solvent in the electrode slurry. The calcination of the electrode material is applied under the inert atmosphere or N₂ and the calcination temperature is 500° C.˜1200° C. and the time is 2˜8 hrs.

In addition, the preparation of electrode (cathode and anode) and the porous ionic conductive polymer binder 140 is already describe elsewhere in the present invention, it will be no longer repeated here.

Hereinbelow, the fabrication process of the lithium ion battery 100 will be described in detail with reference to the following examples, which should not be construed as limiting the scope of the present invention.

### EXAMPLE 1

### The Fabrication of a Lithium Ion Battery

Step 1. 7 g PVDF binder is added into 180 g NMP solvent and mix them thoroughly to form the glue like solution.

Step 2. The cathode slurry is prepared by the following process: The 140 g LiFePO₄ and 2.8 g Super-P conductive carbon is thoroughly mixed into the above glue like solution, mix them thoroughly in the mixer to form a paste like cathode slurry. Use the foamed aluminum with the porosity of 90% as the current collector. Use a doctor blade to coat the cathode slurry onto the both sides of the foamed Al current collector. Put the electrode slurry coated current collector into 110° C. vacuum oven for 4 hrs to remove NMP solvent and dry it. Press the above dried current collector with a rolling press machine to make the active material packed tighter. The targeted thickness after pressing is determined by the battery design, generally at 500 μm including the current collector imbedded inside the electrode material. Calcine the pressed electrode in N₂ atmosphere at 700° C. for 2 hrs, thereafter to cool it to room temperature, withdraw the electrode from the oven to obtain the electrode with a thin layer of carbonized substance coated on the electrode and the current collector. Dip coat a thin layer of porous ionic conductive polymer binder solution onto the current collector holding the electrode active material and the carbonized substance and then put it into the 100° C. vacuum oven to keep 2 hrs to remove solvent and finally to obtain the complex cathode comprising LiFePO₄, the carbonized substance, the current collector and the porous ionic conductive polymer binder.

Step 3. The anode slurry is prepared by the following process: 7 g PVDF binder is added into 180 g NMP solvent, and mix them thoroughly to form a glue like PVDF solution; 70 g Li₄Ti₅O₁₂ and 1.4 g Super-P conductive carbon is thoroughly mixed into the above PVDF solution; mix them thoroughly in the mixer to form a paste like anode slurry. Use the foamed copper with the porosity of 90% as the current collector. Use a doctor blade to coat the anode slurry onto the both sides of the foamed Cu current collector. Put the anode slurry coated current collector into 110° C. vacuum oven for 4 hrs to remove NMP solvent and dry it. Press the above dried current collector with a rolling press machine to make the active material packed more tightly. The targeted thickness after pressing is determined by the battery design, generally at 250 μm including the current collector imbedded inside the electrode material. Calcine the pressed electrode in N2 atmosphere and furthermore calcine the Li4Ti5O12 active anode material filled in the porous copper current collector at 650° C. for 3 hrs, thereafter to cool it to room temperature, withdraw the electrode from the oven to obtain the electrode with a thin layer of carbonized substance coated on the electrode and the current collector. Dip coat a thin layer of porous ionic conductive polymer binder solution onto the current collector having the electrode active material and the carbonized substance and then put it into the 100° C. vacuum oven to keep 2 hrs to remove solvent and finally to obtain the complex anode comprising Li₄Ti₅O₁₂, the carbonized substance, the current collector and the porous ionic conductive polymer binder.

Step 4. Dip coat the abovementioned PVDF binder solution on the separator and remove the solvent by drying the wet separator in an oven to obtain the composite separator containing the porous ionic conductive polymer.

Step 5. The fabrication of the li ion battery: pack the abovementioned composite cathode, composite separator and the composite anode together following the order shown in FIG. 1 and apply a certain stress on the stack at a certain temperature to make the assembling of the battery cell more tightly.

The battery cell assembled according to the technology disclosed in the present invention has the following advantages:

(1) In the embodiment of the invention, the current collector connects with the electrode materials through its porous three-dimensional network construction. Compared with the conventional solid metal foil form of current collector, the porous network current collector in the present invention is effective to improve the active materials utilization and the higher electrode area density. Furthermore, after the calcination process, the distance among the carbonized substance, the electrode material and the current collector is only within the magnitude of nanometers and thus they have close contact with each other. This can effectively relieve the mechanical stress generated from the charge-discharge process and thus to improve the connection stability of the electrode and the current collector and the cycling stability of the battery cell as well.

(2) The pressing step in the electrode fabrication process disclosed in the present invention can be utilized to make a plate-like form of complex electrode with a varied thickness. Therefore the electrode fabricated through this process can satisfy both higher capacity and good mechanical property, especially the anti-bending capability of the electrode. Further, this process can also be used to make a thicker electrode where higher energy density of the battery is demanded.

(3) The cathode and anode and even the separator material are linked together through a porous ionic conductive polymer binder, which also functions in the successive electrode multilayer stack. More importantly, the porous ionic conductive polymer binder builds a bridge among the various electrodes and separators in the multi-cells stack. This setup promotes ionic transportation through different layers and the reduction of cell impedance. On the other hand, the porous polymer binder layer acting as the link is placed on the surface of the electrode. Usually the electrode layer is in a plate-like form. Through the covering of the electrode by the polymer binder, the electrode is well protected and the active material is constrained on the current collector, meanwhile the polymer binder is functioned as the anti-penetration layer to prevent the electrode active material and the carbonized substance loss from the current collector.

(4) In addition, in contrast to the conventional electrode fabrication technique where the electrode directly coated on the solid metal foil, the porous current collector of the present invention connects with the electrode active material through its three-dimensional network construction and this greatly narrows down the distance of the electron transporting to the nanometer level. This novel fabrication method provides more stable interfaces among the different materials and thus effectively relives the stress for the electrode peel-off from the current collector and results in the reduction of the cell impedance during prolonged cycling process. Consequently, the comprehensive electrochemical performance of the battery cell can be improved and the production cost is also reduced.

(5) The porous polymer binder in the current collector and the electrode active material not only affords a tight contact among the different electrodes, but also lowers down the whole battery cell impedance; moreover, it can also prevent the electrode active material loss from the current collector.

In summary, in contrast to the conventional cell fabrication technology, the present invention provides a novel electrode and battery cell fabrication technology which delivers a better comprehensive cell electrochemical and mechanical performance such as a lower cell impedance, a higher active material utilization (and thus a high energy density) and anti-bending capability of the cell.

The present invention is illustrated by way of example and not by way of limitation. It should be noted that references to ‘an’ or ‘one’ embodiment in this disclosure are not necessarily to the same embodiment, and such references mean at least one. In the following description, various aspects of the present invention will be described. However, it will be apparent to those skilled in the art that the present invention maybe practiced with only some or all aspects of the present invention. However, it will be apparent to one skilled in the art that the present invention may be practiced without the specific details. In other instances, well-known features are omitted or simplified in order not to obscure the present invention.

What is claimed is:

1. A lithium ion battery, characters are that: consisting of at least one cathode and one anode layer, the cathode and the anode layer are configured through a separator in between, wherein the cathode or the anode layer comprises:
a current collector with porous three-dimensional network construction;
an electrode active material, filled in the pores of the above mentioned current collector;
a porous ionic conductive polymer binder layer, coating on the above mentioned current collector holding the electrode material.

2. The lithium ion battery of claim 1, wherein the current collector is porous metal foam with the porosity of 20%˜95%.

3. The lithium ion battery of claim 1, wherein the cathode layer comprises the abovementioned current collector and the electrode active material, wherein the electrode active material is a lithium ion compound, selected from at least one of the following: Li₃V₂(PO4)3, LiFeMPO₄, LiMnO₂ and LiFePO₄, wherein M represents Ni, Co, Mn, Mg, Ca, Cr, V, Sr in LiFeMPO₄.

4. The lithium ion battery of claim 1, wherein the anode layer comprises the abovementioned current collector and the electrode active material, wherein the electrode active material is selected from at least one of the following: C, Si, SiO₂, N containing compound, SnO₂, Sb₂O₃ and Li₄Ti₅O₁₂.

5. The lithium ion battery of claim 1, wherein the abovementioned electrode material is coated with a carbonized substance.

6. The lithium ion battery of claim 1, wherein the porous ionic conductive polymer binder is selected from one of the following: polyvinylidene fluoride (PVDF), poly tetrafluoro ethylene (PTFE), polyethylene oxide (PEO), poly (methyl acrylate) (PMA), or acrylate based gel polymer.

7. The lithium ion battery of claim 1, wherein the porous ionic conductive polymer binder has a viscosity of 0.1 Pa.s˜10 Pa.s.

8. The lithium ion battery of claim 1, wherein the separator material is selected from at least one of the following: PE, PP, PE/PP, PP/PE/PP.

9. The lithium ion battery of claim 1, the abovementioned cathode or anode layer is in a plate-like form with a uniform thickness.

10. The lithium ion battery of claim 1, the abovementioned cathode or anode layer comprises the abovementioned current collector, the porous ionic conductive polymer binder coated on the electrode material and the current collector, such that after assembling the cathode, the anode layer and the separator together, the whole piece of battery cell is coated with a layer of porous ionic conductive polymer binder.
